(19) United States
(12) Patent Application Publication
(10) Pub. No.: US 2026/0192943 A1
(43) Pub. Date: Jul. 9, 2026

(54) AIRCRAFT TUG

(71) Applicants: Ryan Fogg, Holland, MI (US); Jeff Persenaire, Holland, MI (US)

(72) Inventors: Ryan Fogg, Holland, MI (US); Jeff Persenaire, Holland, MI (US)

(21) Appl. No.: 19/014,710

(22) Filed: Jan. 9, 2025

(51) Int. Cl. B64F 1/225; B60K 11/00; B60L 7/10; B60L 53/16

(52) U.S. Cl. CPC B64F 1/225; B60L 7/10; B60L 53/16; B60K 11/00; B60L 2200/40

(57) ABSTRACT

An aircraft tug for moving aircraft on the ground, including: (a) a body/chassis that is responsive to operator control; (b) at least one ground-engaging drive wheel, wherein the at least one ground-engaging drive wheel is associated with the body/chassis; and (c) wherein the tug includes a low clearance front and a boom/mast extension that increase visibility, as well as improve safety while transporting aircraft on the ground relative to conventional tugs.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to aircraft tugs, and, more particularly, to aircraft tugs that have a low clearance front and a boom extension that increase visibility, as well as improve safety while transporting aircraft on the ground. The aircraft tugs of the present invention are also configured as an affordable, daily use electric vehicle (EV). The aircraft tugs of the present invention are yet further adapted to be integrated with a portable aircraft collision avoidance system.

### 2. Background Art

Aircraft tugs have been known in the art for years, and are the subject of a plurality of patents including, for example: U.S. Pat. No. 9,056,686 entitled “Aircraft Tug Vehicle,” U.S. Pat. No. 8,181,725 entitled “Aircraft Tug,” U.S. Pat. No. 7,506,707 entitled “Guided Airplane Relocating Device,” U.S. Pat. No. 6,945,354 entitled “Aircraft Handler,” U.S. Pat. No. 6,896,283 entitled “Aircraft Tug Hitch Assembly,” U.S. Pat. No. 6,305,484 entitled “Automated Aircraft Towing Vehicle System,” U.S. Pat. No. 6,283,696 entitled “Aircraft Towing Vehicle,” U.S. Pat. No. 5,480,274 entitled “Aircraft Tug Without Tow Bar,” U.S. Pat. No. 5,261,778 entitled “Universal Aircraft Tug Assembly,” U.S. Pat. No. 4,991,862 entitled “Aircraft Towing Apparatus,” United States Patent Application Publication Number 2011/0224845 entitled “Towbarless Airplane Tug,” and United States Patent Application Publication Number 2003/0095854 entitled “Tug for Aircraft”—all of which are hereby incorporated herein by reference in their entirety including all references cited therein.

U.S. Pat. No. 9,056,686 appears to disclose an improved aircraft towing vehicle that includes a base plate, a controller and two drive motors supported by two track assemblies. A pivoting wheel constraint mechanism rests on the base plate and includes a front roller mount, a rear roller mount and a linkage connecting the front roller mount and the rear roller mount. When the rear roller mount is pushed or otherwise urged backward, the linkage causes the front roller mount to pivot upward to confine an aircraft wheel on the base plate. A latch keep is also connected to the base plate for holding the rear roller mount in the backward position and locking the wheel constraining mechanism for moving an aircraft.

U.S. Pat. No. 8,181,725 appears to disclose an aircraft tug that includes a chassis and a tow bar which extends from the chassis. The tow bar includes a first arm and a second arm which are operable to autonomously selectively attach with an aircraft main landing gear assembly. The tow bar also includes an engagement system that is operable to engage the aircraft main gear assembly such that the first arm is located adjacent to one side of one landing gear tire and the second arm is located adjacent to the other side of one landing gear tire. The aircraft tug also includes a drive drum which selectively rotates about an axis of rotation between the first arm and the second arm to selectively drive the one landing gear tire. A tug power connector is mounted to the engagement system operable to autonomously connect with an aircraft ground electric power connection located on the aircraft main landing gear assembly to transfer electrical power therebetween.

U.S. Pat. No. 7,506,707 appears to disclose a guided vehicle relocation device which has a frame. The frame has an opening to allow one or more wheels of a vehicle to enter an interior area of the frame. At least one drive mechanism is coupled to the frame. The drive mechanism engages the wheel of the vehicle, rotating the wheel of the vehicle to move the vehicle. A control panel is coupled to the frame and to the at least one drive mechanism. The control panel is used for controlling operation of the guided vehicle relocation device.

U.S. Pat. No. 6,945,354 appears to disclose an aircraft handler for use with an undercarriage of an aircraft, the handler being self-propelled and comprising a generally “U” shaped body having arms linked by a bridge at one end thereof with a pair of drive wheels located one at the free end of each arm, with at least one wheel located adjacent the bridge. A pair of clamping jaws are mounted on the body between the drive wheels and the bridge and jaws have a lower profile than the arms. The drive wheels are driven by DC electric motors powered by batteries stored in the arms.

U.S. Pat. No. 6,896,283 appears to disclose an aircraft tug hitch assembly which includes deflectable guide plates providing a converging pocket for mechanically positioning a tow bar eyelet with the hitch lock pin. The hitch includes a lock assembly including a lock pin is mounted on a slidable piston for operator controlled movement between a detented raised unlocked position and a lower locked position capturing the tow bar eyelet. An indicator ball carried by the piston is observable by the tug operator when the lock assembly is in the unlocked position, but is not visible in the locked position thereby confirming hitch status without the need for verbal communication with ground personnel.

U.S. Pat. No. 6,305,484 appears to disclose an automated aircraft towing vehicle system for use with aircraft. When coupled to an aircraft the towing tractor vehicle facilitates the movement of the aircraft without the requirement for use of the aircraft's jet engines. The towing vehicle system comprises a towing tractor vehicle having remotely controllable steering, braking, and acceleration. The remote system controller is located in the aircraft being towed such that the pilot of the aircraft being towed is capable of controlling the starting, stopping and steering of the towing tractor vehicle. The towing tractor vehicle further includes a remotely controllable de-coupling means. When the aircraft is towed to the desired location, the decoupling of the aircraft from the towing tractor vehicle is controllable by the remote system controller.

U.S. Pat. No. 6,283,696 appears to disclose an aircraft towing vehicle that includes a lifting and locking device for the nose landing gear of the aircraft being towed. The device has two support elements which reach behind the nose wheels and can be displaced along straight-line guiding rails by a linear drive so as to pull the nose wheels of the aircraft onto a lifting platform and to lock it into place thereon. At the end of each guiding rail a guiding pin is provided which, in cooperation with a guiding track embodied in the support element, controls the rotation of the support element into a release position in which the nose landing gear is able to pass through. By a reverse movement, the rotation of the support elements is put into the operation position in which the support elements reach behind the nose landing gear.

U.S. Pat. No. 5,480,274 appears to disclose an aircraft tug without draw tongue, with a chassis divided by means of an axially parallel buckling axle. The pickup device for the nose landing gear (nose wheels) of an aircraft is arranged within the fork-shaped recess of the chassis, which is formed by the lifting rockers. This pickup device includes a lifting platform, a pendulum tie-bar, telescopic arms with gripping arms, a push-out tie-bar, a crossbar, longitudinal swinging arms, and a pendulum pin. The pendulum tie-bar, the lifting platform with the telescopic arms, including the push-out tie-bar and the longitudinal swinging arms, are connected to the lifting rockers of the chassis rear part via coupling members. The pendulum tie-bar has a pendular mounting, and pendular movement of the lifting platform and of the pendulum tie-bar is guaranteed in conjunction with the pivotably mounted lifting platform. Since the height-adjustable telescopic arms are pivotably linked to the lifting platform and to the pendulum tie-bar, they are able to participate in the pendular movement.

U.S. Pat. No. 5,261,778 appears to disclose an aircraft tug assembly for moving an aircraft on the ground. The tug assembly includes a self-propelled chassis responsive to operator control. A cradle assembly is pivotally attached to a front portion of the chassis. The cradle assembly has an adjustable nosewheel receiving apparatus comprising two lateral arms adjustably engaged with a rear gate to define a nosewheel receiving corral therebetween, with the corral sizable to accommodate varying sized aircraft nosewheels. The chassis has a winch for pulling an aircraft nosewheel onto the cradle assembly and into the corral. An optional front gate may be used to enclose the nosewheel within the corral. Hydraulic actuators lift the cradle assembly with the nosewheel thereon so the tug assembly may move the aircraft without starting the aircraft engine.

U.S. Pat. No. 4,991,862 appears to disclose a universal tow and coupling bar for connecting automatically to an aircraft landing nose gear and towing the aircraft during ground transport. The aircraft engaging end of the tow bar has directional adjustment and is hydraulically controlled in three coordinates. The end of the tow bar opposite to the aircraft engaging end is semi permanently connected to the aircraft towing vehicle. The aircraft engaging end of the tow bar contains an automatic hydraulically controlled locking assembly arranged to engage and lock with a mating locking assembly permanently fixed to the aircraft nose wheel structure. In addition to the aforementioned features of the universal tow bar are means for controlling the length of the tow bar, interrupting the aircraft's hydraulic steering system, and connecting to the aircraft's telephone system. This invention provides for the automatic coupling of a towing vehicle to most jet aircraft under the control of a single operator functioning from the cab of the towing vehicle.

United States Patent Application Publication Number 2011/0224845 appears to disclose a towbarless airplane tug which is configured for receiving a landing gear of an airplane and towing it thereby. The tug comprises a chassis configured for receiving thereon at least a portion of the landing gear, a propulsion arrangement configured to move the tug in a direction along a trajectory, at least one force sensor configured to measure, directly or indirectly, a force exerted by the chassis on the landing gear in at least the direction due to a speed differential between the tug and the airplane, and a controller in communication with the force sensor and being configured to alter one or more parameters of movement of the tug such that the force exerted by the chassis on the landing gear is maintained below a predetermined value. The propulsion arrangement comprises a variable angle swash plate hydraulic pump coupled to a variable angle swash plate hydraulic motor and to a controllable bypass path valve, configured such that a hydraulic fluid circulates between the pump and the motor so as to activate the propulsion arrangement to increase at least one of the speed and the traction force of the tug when the bypass path is in a closed state, and at least most of the hydraulic fluid circulates across the motor via the bypass path valve so as to reduce at least one of a rotational speed and traction force of the tug when the bypass path is in a opened state. The controller alters the parameters by regulating at least the power available to the propulsion arrangement, the pump and motor swash-plates, and the state of the bypass path valve.

United States Patent Application Publication Number 2003/0095854 appears to disclose an articulated tractor for towing an aircraft that includes a front section including an engine means and a rear section pivoted to the front section, the rear section defining a nose wheel clamp means for engaging and raising the nose wheel of an aircraft. In another embodiment the clamping force applied to the nose wheel by the nose wheel clamp means is proportional to the mass of the nose wheel. Still in another embodiment the nose wheel clamp means are included with relief valve means to relieve if the raising force applied to the nose wheel increases beyond a predetermined limit.

While the above-identified patents and publications do appear to disclose various aircraft tugs, their configurations remain non-desirous and/or problematic inasmuch as, among other things, none of the above-identified tugs: (1) utilize a low clearance front end; (2) incorporate an extendable boom as disclosed herein; (3) are configured as an affordable, daily use EV; and (4) incorporate a portable aircraft collision avoidance system.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to an aircraft tug for moving aircraft on the ground comprising, consisting essentially of, and/or consisting of: (a) a body/chassis that is responsive to operator control; (b) at least one ground-engaging drive wheel, wherein the at least one ground-engaging drive wheel is associated with the chassis; and (c) wherein the tug includes a low clearance front and a boom/mast extension that increase visibility, as well as improve safety while transporting aircraft on the ground relative to conventional tugs.

In a preferred embodiment of the present invention, the aircraft tug is configured as an affordable, daily use electric vehicle.

In another preferred embodiment of the present invention, the aircraft tug is adapted to be integrated with a portable aircraft collision avoidance system.

In yet another preferred embodiment of the present invention, the aircraft tug further comprises a lift assembly.

In one preferred embodiment of the present invention, the aircraft tug further comprises a front wheel scoop assembly.

In a preferred implementation of the present invention, the aircraft tug further comprises a front axle assembly.

In another preferred implementation of the present invention, the aircraft tug further comprises a steering console assembly.

In yet another preferred implementation of the present invention, the aircraft tug further comprises a side mast assembly having a pair of extendable side masts.

In one preferred implementation of the present invention, the aircraft tug further comprises a scoop connector assembly.

In a preferred embodiment of the present invention, the aircraft tug further comprises a back wall mount hitch receiver.

In another preferred embodiment of the present invention, the aircraft tug further comprises a strap winch assembly.

In yet another preferred embodiment of the present invention, the aircraft tug further comprises a wireway assembly and/or a wireway roller assembly.

In a preferred embodiment of the present invention, the aircraft tug further comprises one or more of a lift assembly, a front wheel scoop assembly, a front axle assembly, a steering console assembly, a side mast assembly having a pair of extendable side masts, a scoop connector assembly, a wall mount hitch receiver, a strap winch assembly, a wireway assembly, a wireway roller assembly, and combinations thereof.

The present invention is also directed to an aircraft tug for moving aircraft on the ground, comprising, consisting essentially of, and/or consisting of:
(a) a chassis that is responsive to operator control; (b) at least one ground-engaging drive wheel, wherein the at least one ground-engaging drive wheel is associated with the chassis; and (c) a lift assembly, a front wheel scoop assembly, a front axle assembly, a steering console assembly, a side mast assembly having a pair of extendable side masts, a scoop connector assembly, a wall mount hitch receiver, a strap winch assembly, a wireway assembly, and a wireway roller assembly.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1A of the drawings is an exploded perspective view of an aircraft tug of the present invention;

FIG. 1B of the drawings is a rear perspective view of the aircraft tug of FIG. 1A;

FIG. 1C of the drawings is a top view of the aircraft tug of FIG. 1A;

FIG. 1D of the drawings is a side view of the aircraft tug of FIG. 1A;

FIG. 1E of the drawings is a rear view of the aircraft tug of FIG. 1A;

FIG. 2A of the drawings is an exploded perspective view of a lift assembly of the present invention;

FIG. 2B of the drawings is a side view of the lift assembly of FIG. 2A;

FIG. 2C of the drawings is a top view of the lift assembly of FIG. 2A;

FIG. 2D of the drawings is a bottom view of the lift assembly of FIG. 2A;

FIG. 3A of the drawings is an exploded perspective view of a front wheel scoop assembly of the present invention;

FIG. 3B of the drawings is a perspective view of the front wheel scoop assembly of FIG. 3A;

FIG. 4A of the drawings is an exploded perspective view of a front axle assembly of the present invention;

FIG. 4B of the drawings is a perspective view of the front axle assembly of FIG. 4A;

FIG. 4C of the drawings is a side view of the front axle assembly of FIG. 4A;

FIG. 4D of the drawings is a cross-sectional view of the front axle assembly taken along line A-A of FIG. 4C;

FIG. 4E of the drawings is a cross-sectional view of the front axle assembly taken along line B-B of FIG. 4C;

FIG. 5A of the drawings is an exploded perspective view of a steering console assembly of the present invention;

FIG. 6A of the drawings is an exploded perspective view of a side mast assembly of the present invention;

FIG. 6B of the drawings is a front view of the side mast assembly of FIG. 6A;

FIG. 6C of the drawings is a fragmented side view of the side mast assembly of FIG. 6A;

FIG. 6D of the drawings is a fragmented cross-sectional view of the side mast assembly taken along line C-C of FIG. 6C;

FIG. 7A of the drawings is an exploded perspective view of a GPU access door assembly of the present invention;

FIG. 7B of the drawings is a rear perspective view of the GPU access door assembly of FIG. 7A;

FIG. 8A of the drawings is an exploded perspective view of a scoop connector assembly of the present invention;

FIG. 8B of the drawings is a perspective view of the scoop connector assembly of FIG. 8A;

FIG. 9A of the drawings is an exploded perspective view of a front compartment cover assembly of the present invention;

FIG. 9B of the drawings is a perspective view of the front compartment cover assembly of FIG. 9A;

FIG. 10A of the drawings is an exploded perspective view of a rear compartment cover assembly of the present invention;

FIG. 10B of the drawings is a perspective view of the rear compartment cover assembly of FIG. 10A;

FIG. 11A of the drawings is an exploded perspective view of a tool storage cover of the present invention;

FIG. 11B of the drawings is a perspective view of the tool storage cover of FIG. 11A;

FIG. 12A of the drawings is an exploded perspective view of a strap winch assembly of the present invention;

FIG. 12B of the drawings is a perspective view of the strap winch assembly of FIG. 12A;

FIG. 13A of the drawings is an exploded perspective view of a wireway assembly of the present invention;

FIG. 13B of the drawings is a side view of the wireway assembly of FIG. 13A;

FIG. 14A of the drawings is an exploded perspective view of a wireway roller assembly of the present invention; and

FIG. 14B of the drawings is a perspective view of the wireway roller assembly of FIG. 14A.

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

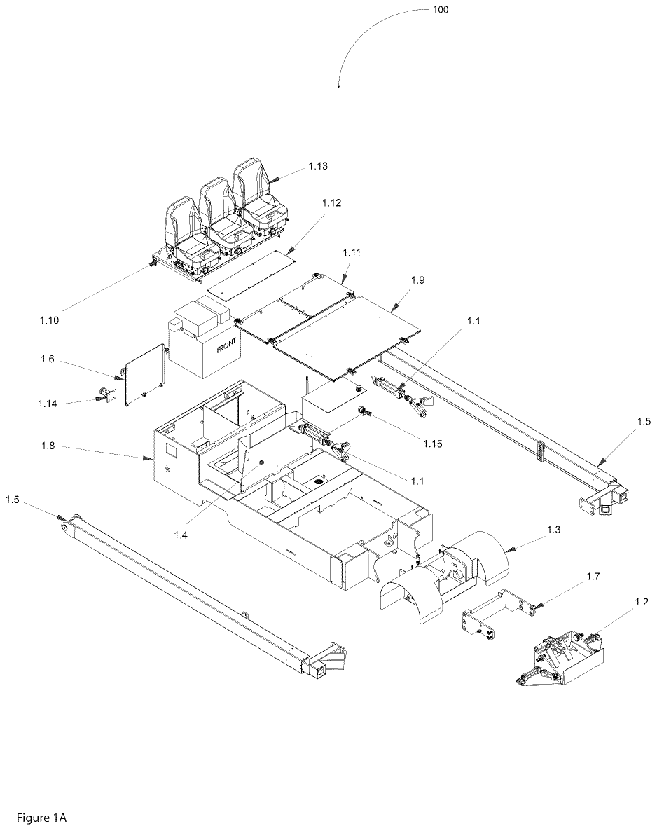

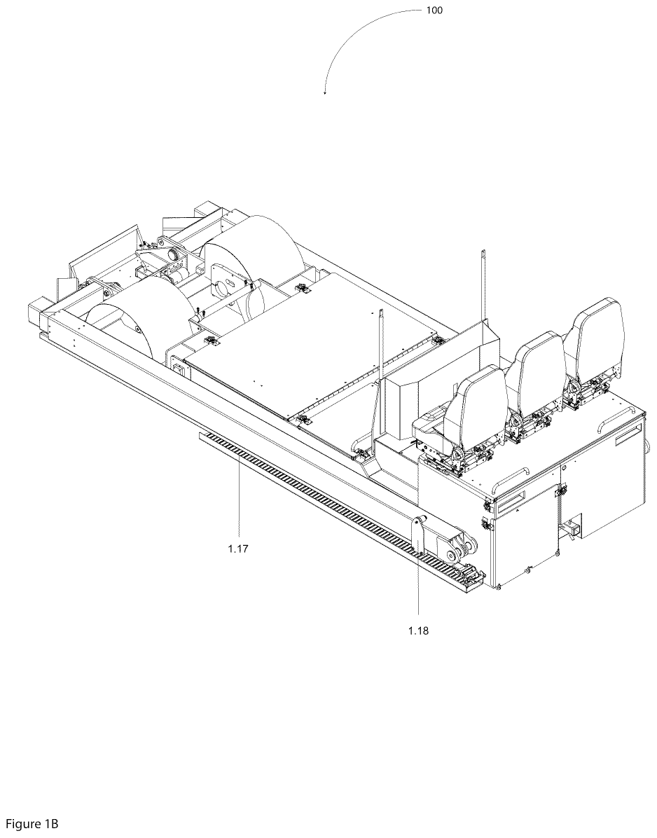

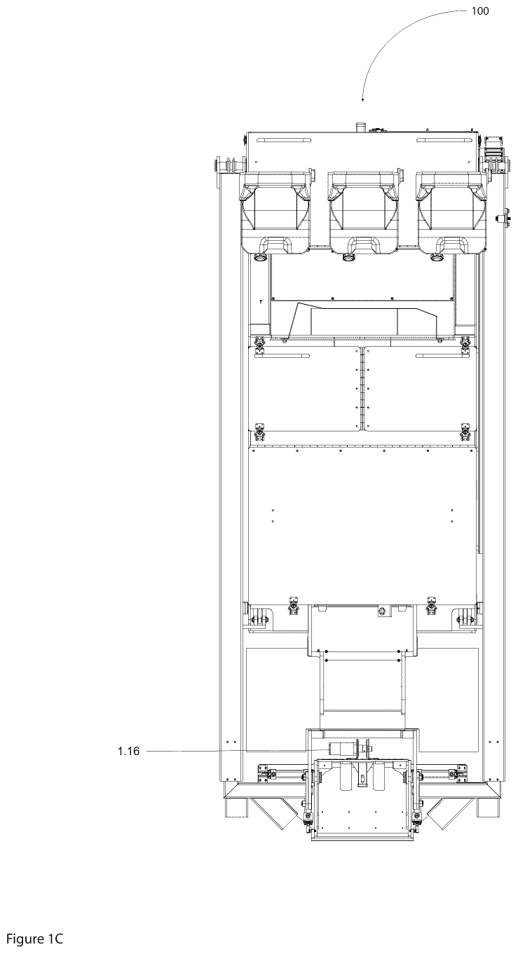

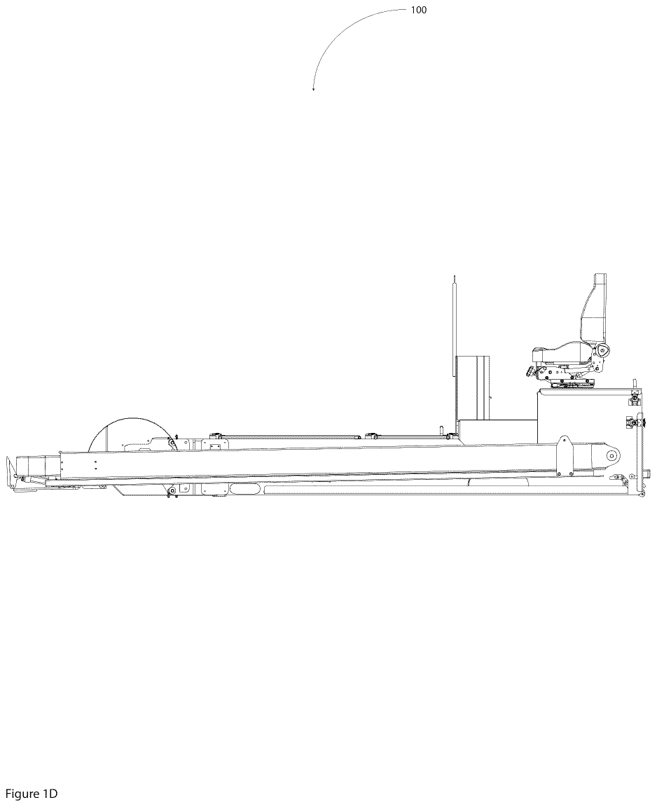

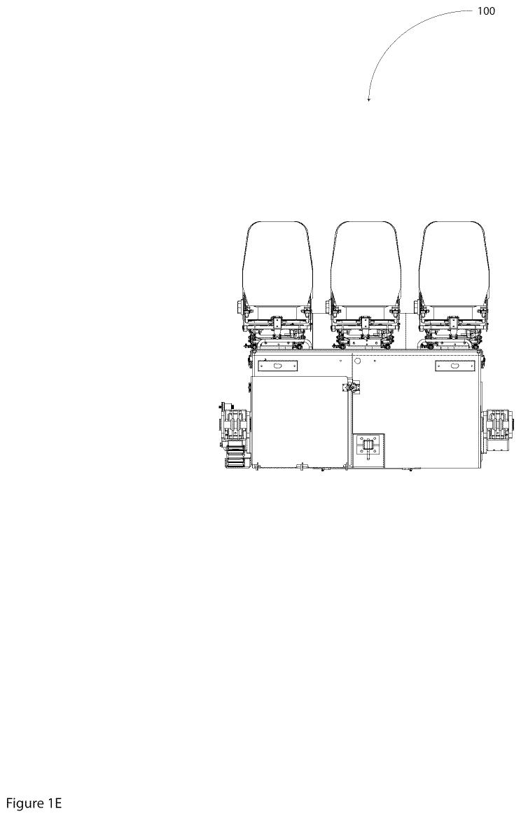

Referring now to the drawings, and to FIGS. 1A-1E in particular, a first embodiment of aircraft tug 100, for moving aircraft on the ground, is shown as generally comprising a pair of lift assemblies 1.1, front wheel scoop assembly 1.2, front axle assembly 1.3, steering console assembly 1.4, a pair of side mast/boom assemblies 1.5, ground power unit (GPU) access door assembly 1.6, scoop connector assembly 1.7, main body/chassis weldment 1.8, front compartment cover assembly 1.9, rear compartment cover 1.10, tool storage cover 1.11, floor plate 1.12, one or more seats 1.13, wall mount hitch receiver 1.14, reservoir 1.15, strap winch assembly 1.16, wireway assembly 1.17, and wireway roller assembly 1.18. Side mast/boom assemblies 1.5 are extendable from a retracted position to an extended position. These booms also pivot near the rear so that they can be controllably raised proximate the front of the tug. The body/chassis of tug 100 is responsive to operator (i.e., a human) controls. These controls and drive system are preferably analogous to those used in commercially available Hitachi GLS EV forklifts. This configuration enables aircraft tug 100 to serve as an affordable, daily use electric vehicle. Tug 100 of the present invention includes at least one ground-engaging drive wheel, wherein the at least one ground-engaging drive wheel is associated with the chassis. Tug 100 of the present invention also includes a low clearance front and a boom/mast extension that increase visibility, as well as improve safety while transporting aircraft on the ground relative to conventional tugs.

In addition, tug 100 is adapted to be integrated with a portable aircraft collision avoidance system, such as those disclosed in U.S. Pat. No. 8,264,377 entitled “Aircraft Collision Avoidance System,” U.S. Pat. No. 8,803,710 entitled “Aircraft Collision Avoidance System,” U.S. Pat. No. 10,013,888 entitled “Aircraft Collision Avoidance System,” U.S. Pat. No. 10,431,104 entitled “Aircraft Collision Avoidance System,” U.S. Pat. No. 11,682,313 entitled “Sensor Assembly for Use in Association with Aircraft Collision Avoidance System and Method of Using the Same,” and U.S. Pat. No. 12,002,372 entitled “Sensor Assembly for Use in Association with Aircraft Collision Avoidance System and Method of Using the Same”—all of which are hereby incorporated herein by reference in their entirety including all references cited therein.

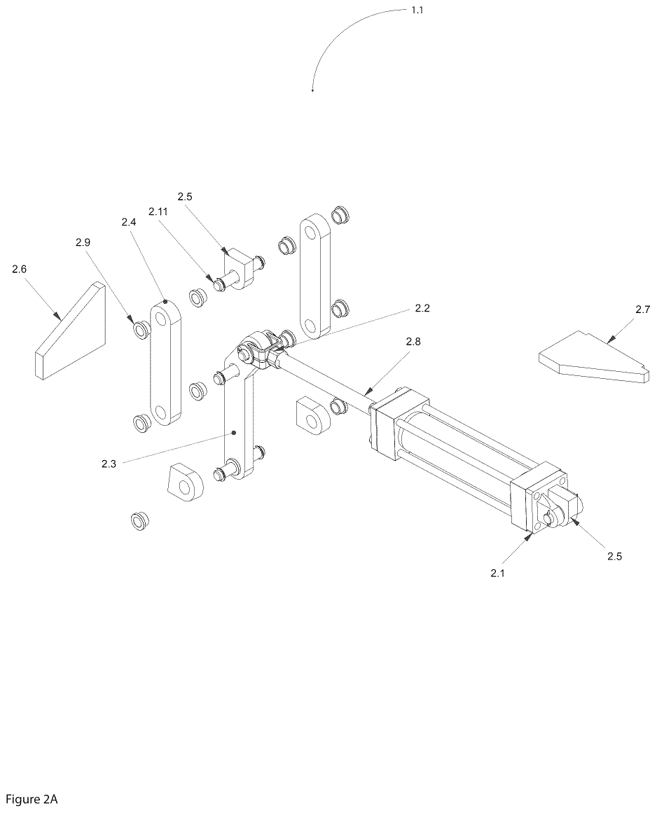

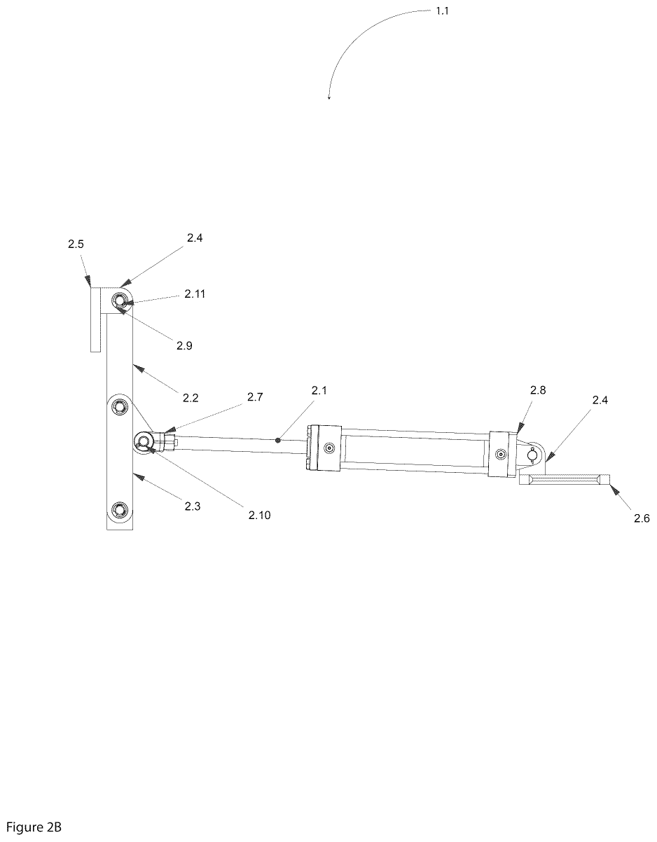

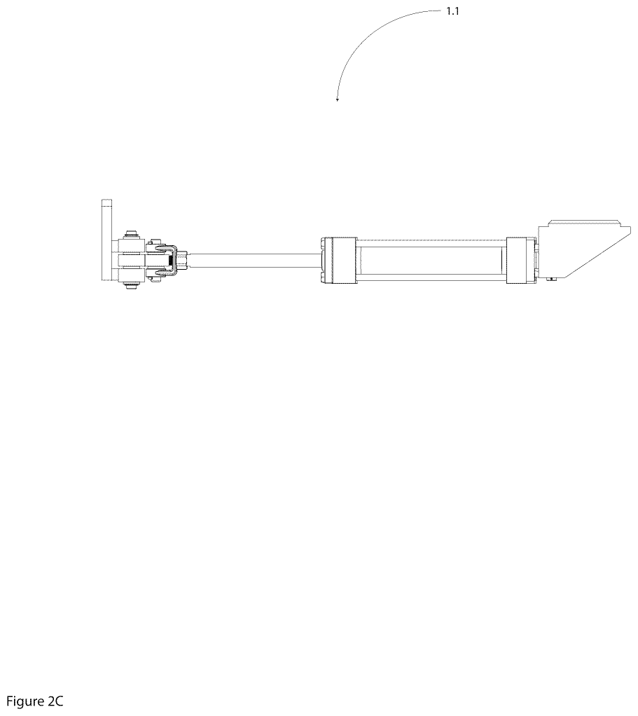

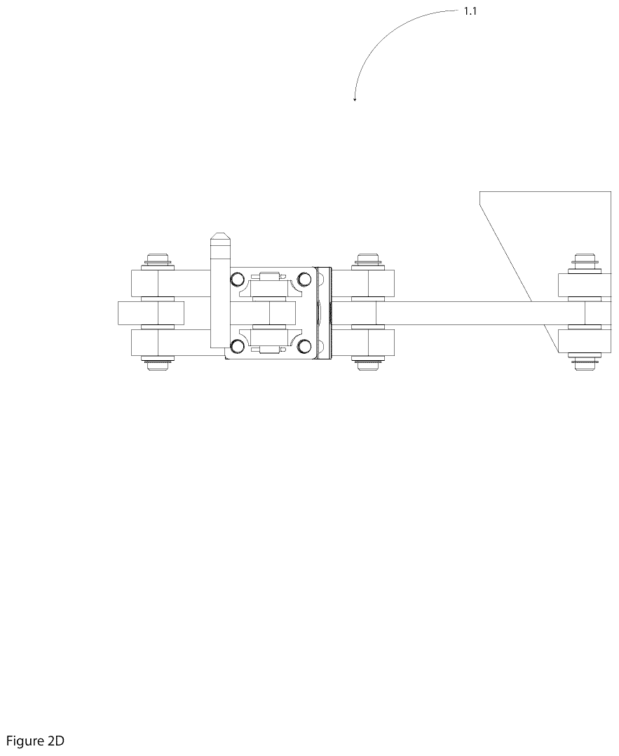

Referring now to FIGS. 2A-2D, lift assembly 1.1 of tug 100 preferably includes hydraulic cylinder 2.1, cylinder lift link 2.2, a pair of lift links 2.3, linkage tabs 2.4, linkage gusset 2.5, cylinder gusset 2.6, clevis rod end 2.7, clevis bracket 2.8, flanged sleeve bearings 2.9, headless clevis pin 2.10, and clevis pins 2.11.

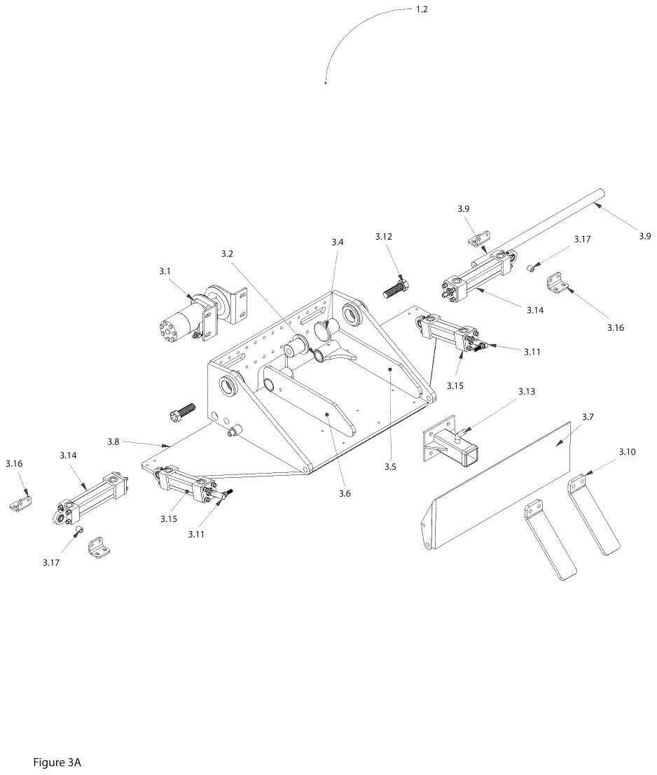

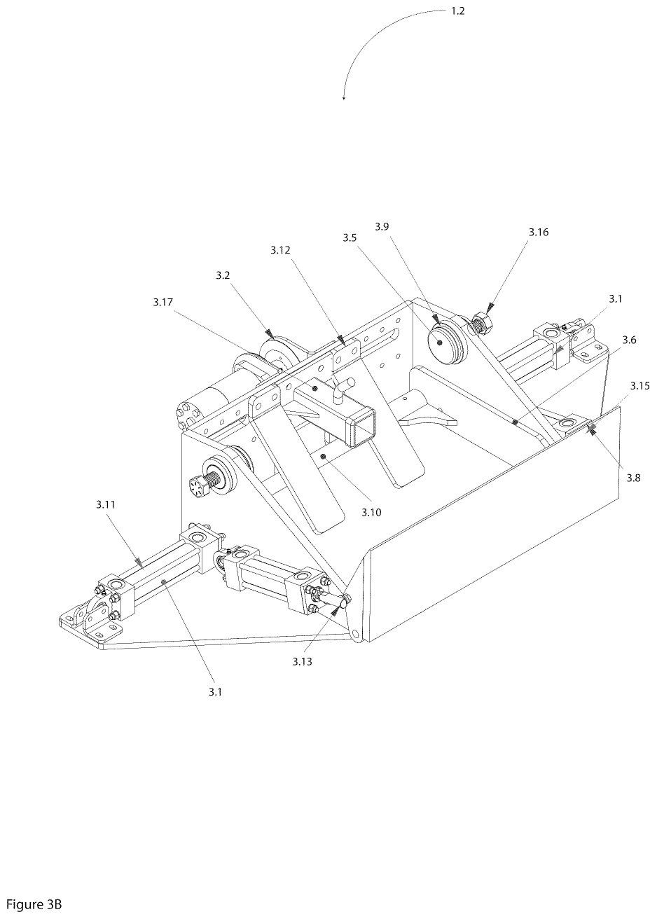

As is best shown in FIGS. 3A-3B, front wheel scoop assembly 1.2 of tug 100 preferably includes strap winch assembly 3.1, paddle bushings 3.2, wear pad 3.3, scoop pivot pins 3.4, front wheel paddle weldment 3.5, wheel paddle weldment 3.6, scoop gate weldment 3.7, front wheel scoop weldment 3.8, slide rod 3.9, wheel ramps 3.10, ball joint linkages 3.11, threaded fasteners 3.12, back wall mount hitch receiver 3.13, first articulable component 3.14, second articulable component 3.15, cylinder tail brackets 3.16, and spacers 3.17.

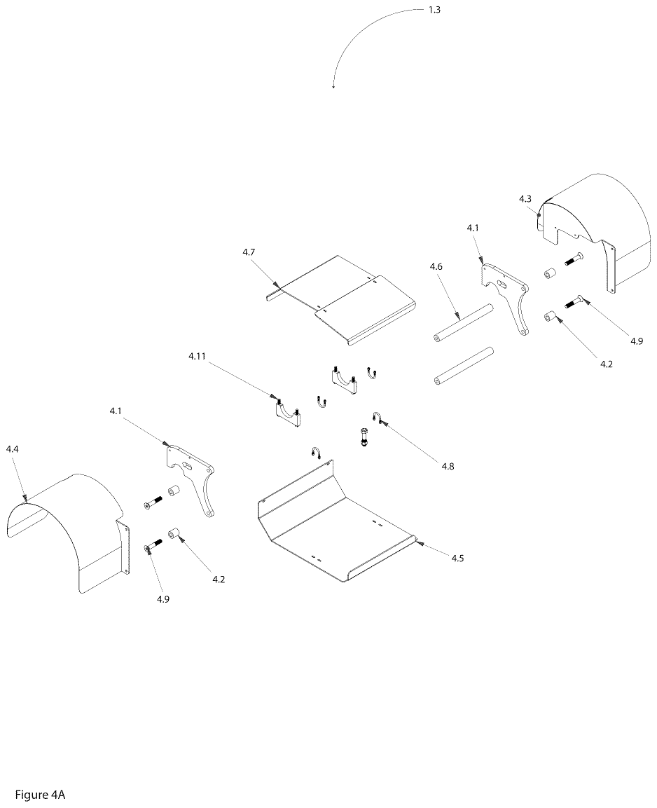

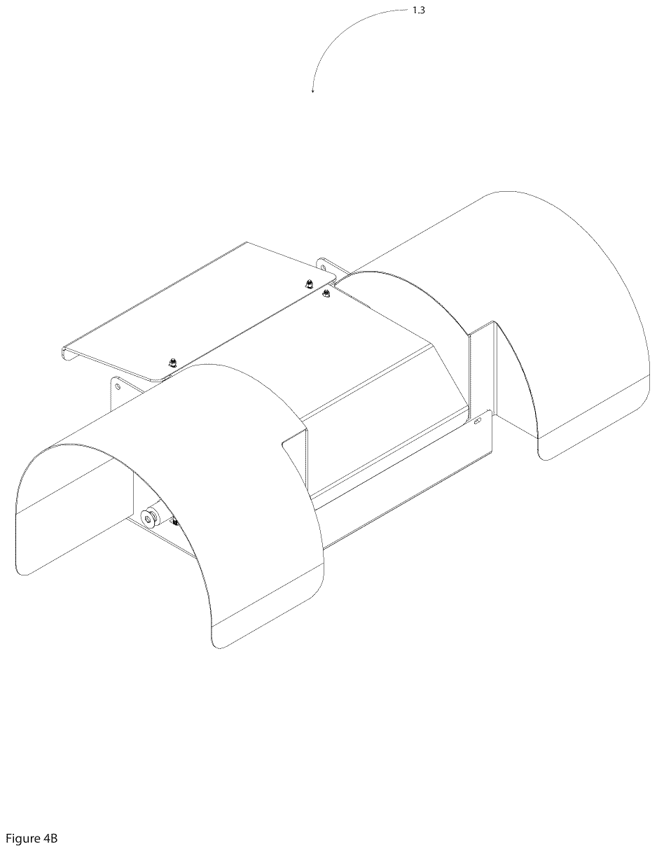

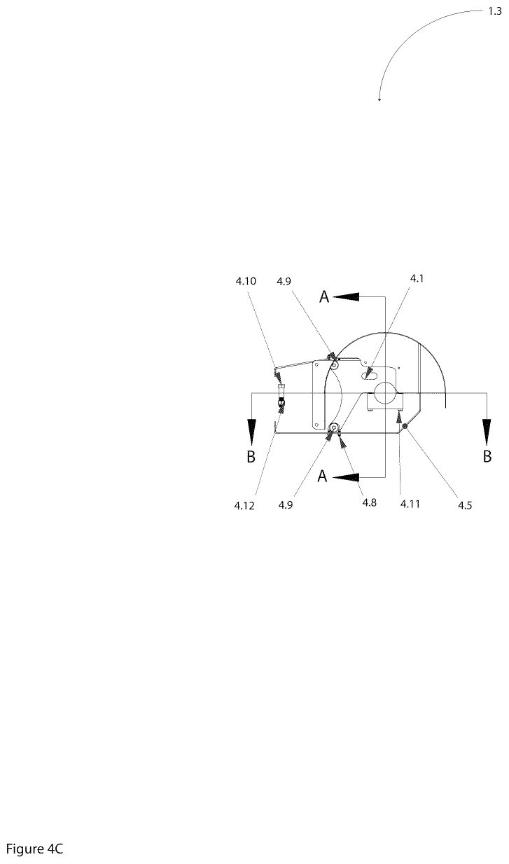

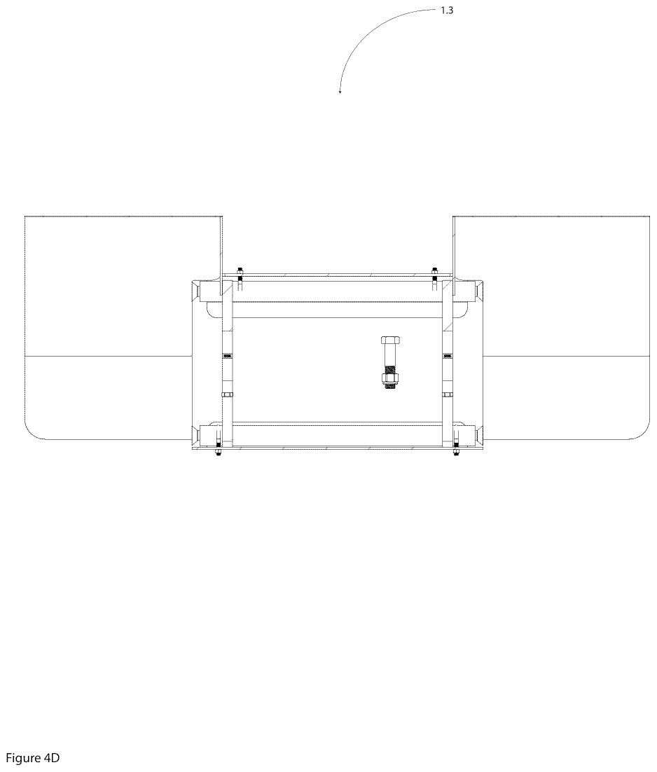

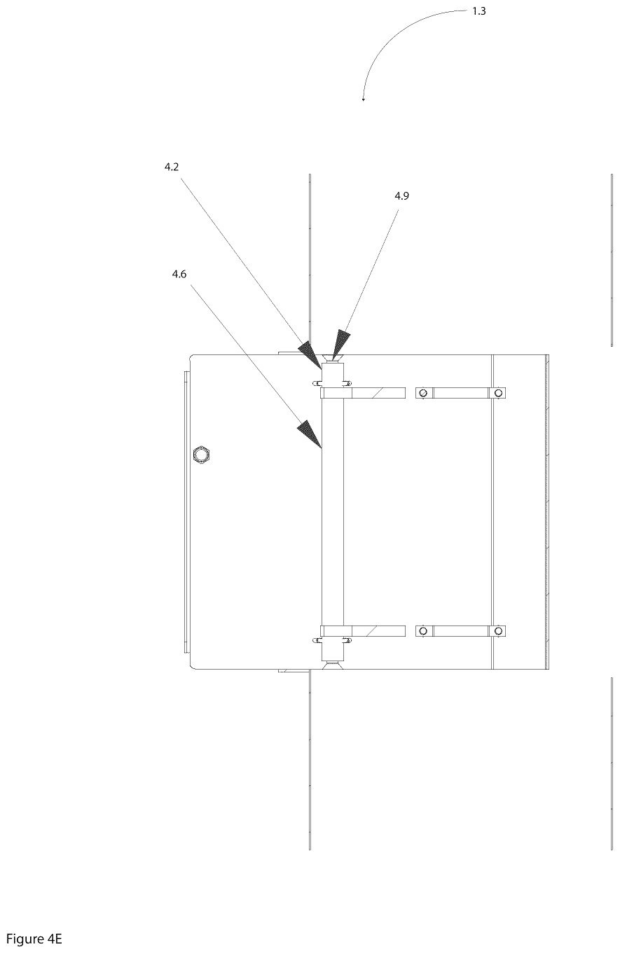

Referring now to FIGS. 4A-4E, front axle assembly 1.3 of tug 100 preferably includes front wheel mounting plates 4.1, front wheel spacers 4.2, left side fender weldment 4.3, right side fender weldment 4.4, bottom skid plate 4.5, front wheel spacers 4.6, top guard 4.7, u-bolts 4.8, threaded fasteners 4.9-11, and lock nut 4.12.

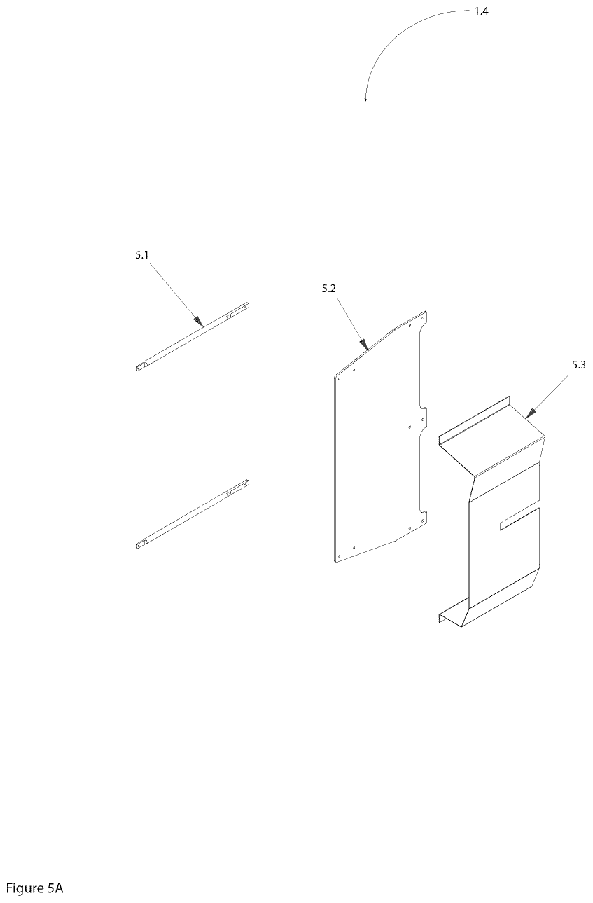

As is best shown in FIG. 5A, steering console assembly 1.4 of tug 100 preferably includes horizontal supports 5.1, back plate 5.2, and front plate 5.3.

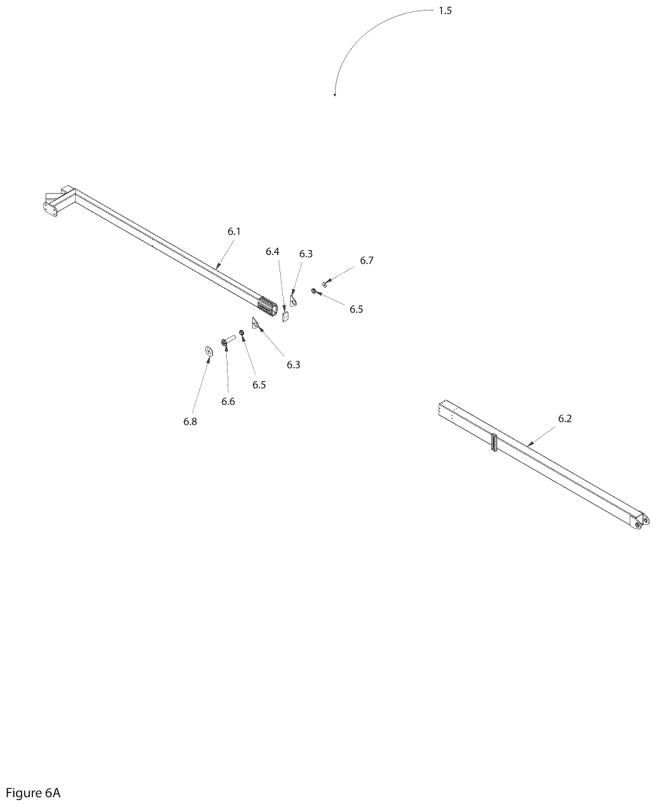

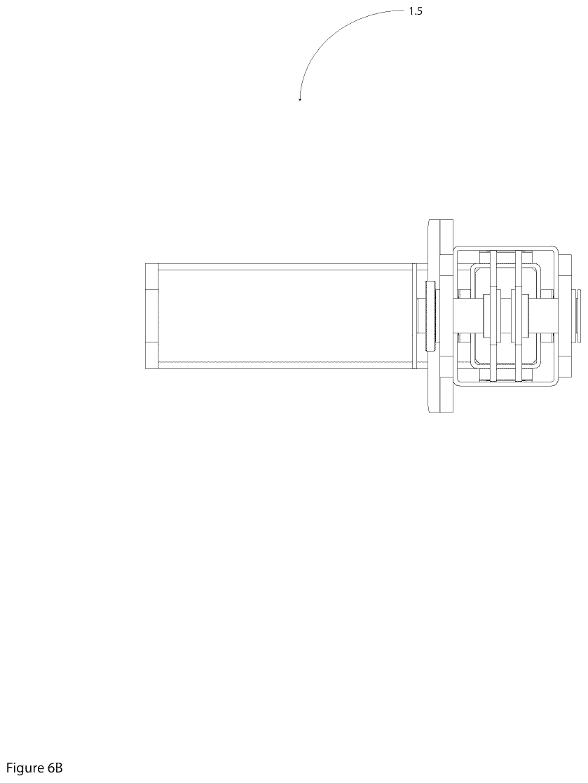

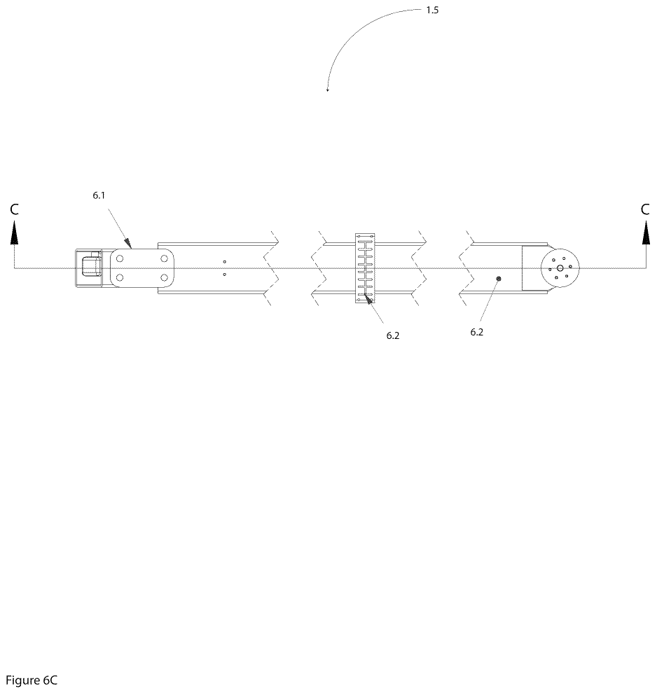

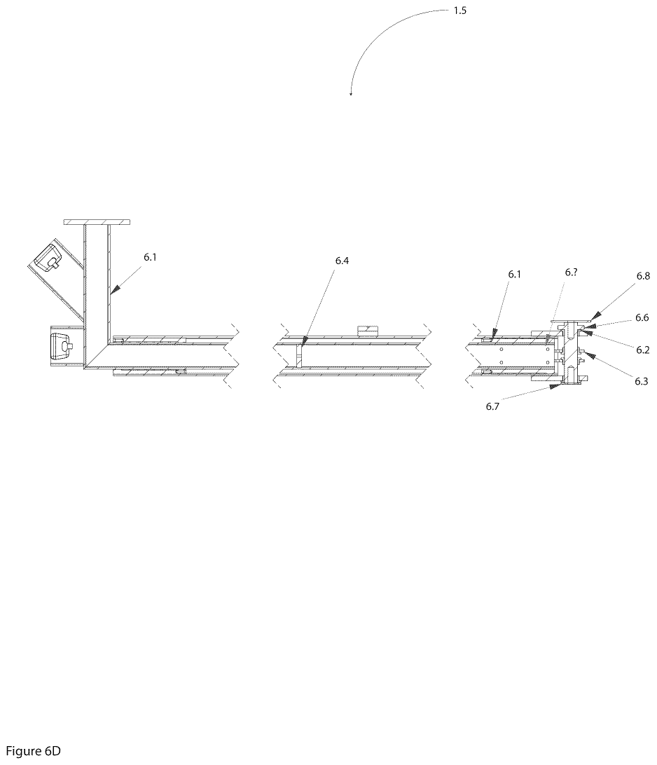

Referring now to FIGS. 6A-6D, side booms/masts 1.5 of tug 100 are slidably extendable and preferably include inside mast assembly 6.1, outside mast assembly 6.2, cylinder tail plates 6.3, cylinder push pull plate 6.4, bushings 6.5, pivot pin 6.6, mast washer 6.7, and pivot retainer plate 6.8.

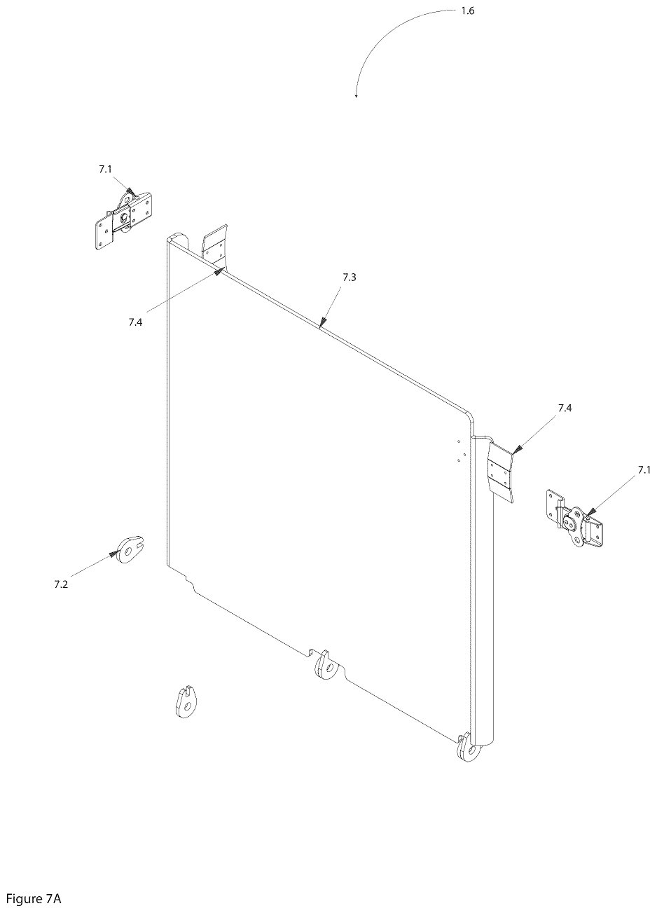

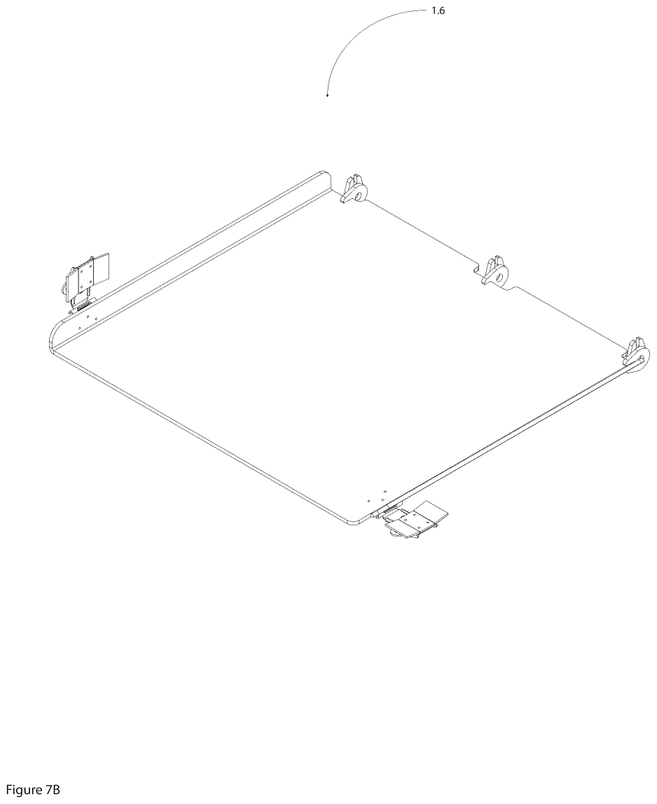

As is best shown in FIG. 7A-7B, GPU access door assembly 1.6 of tug 100 preferably includes turn-to-open draw latches 7.1, hinges 7.2, rear door 7.3, and latch tap plates 7.4.

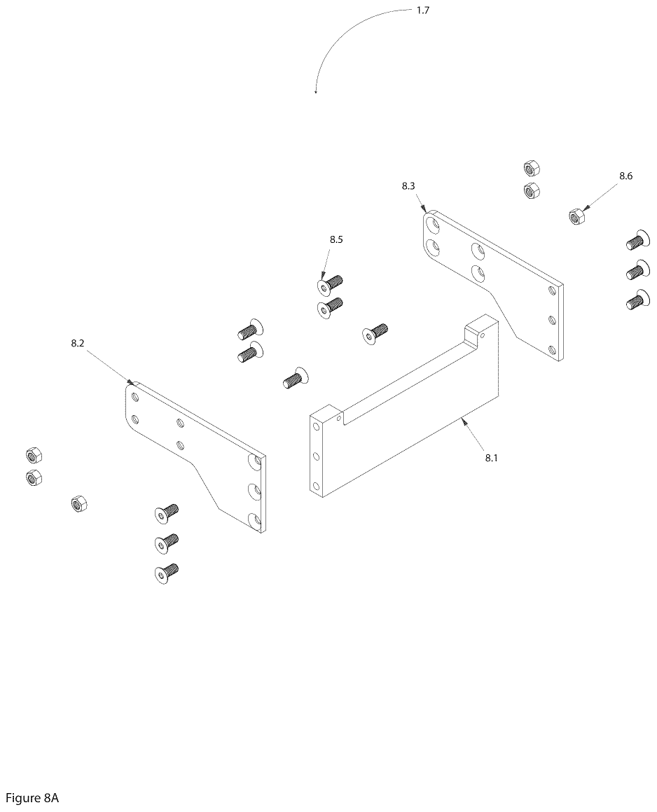

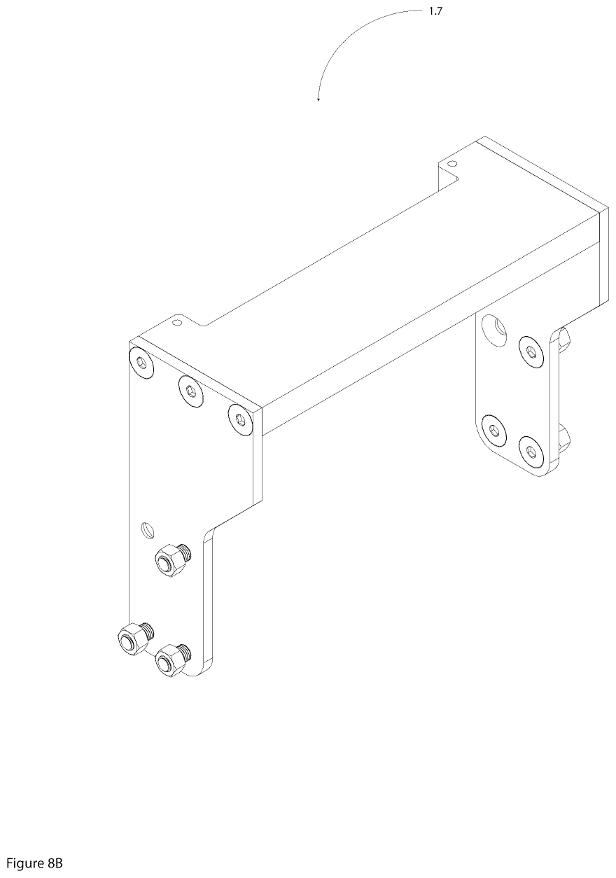

Referring now to FIGS. 8A-8B, scoop connector assembly 1.7 of tug 100 preferably includes mast end plate 8.1, front scoop side plate 8.2, front scoop side plate 8.3, threaded fasteners 8.4-5, and nuts 8.6.

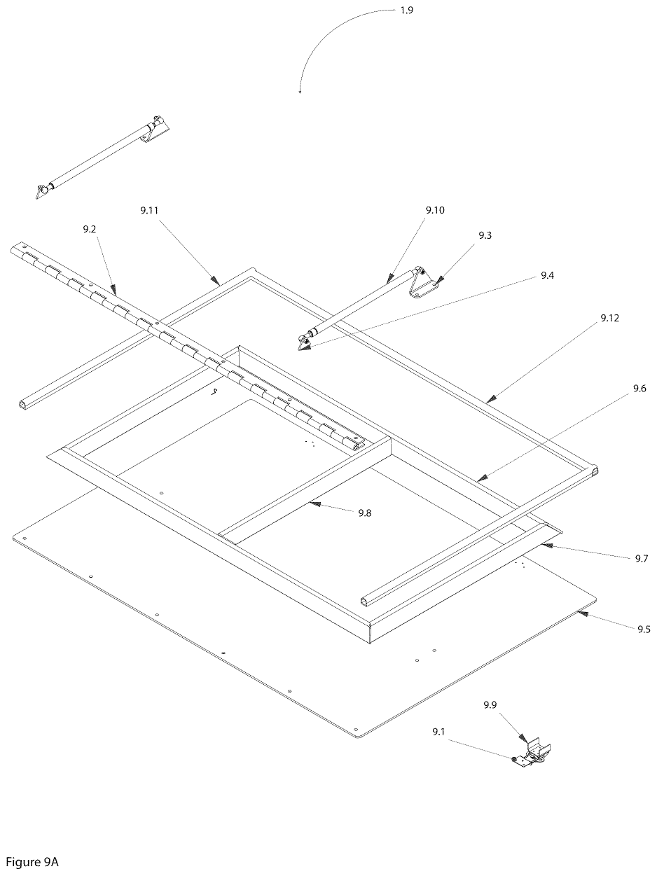

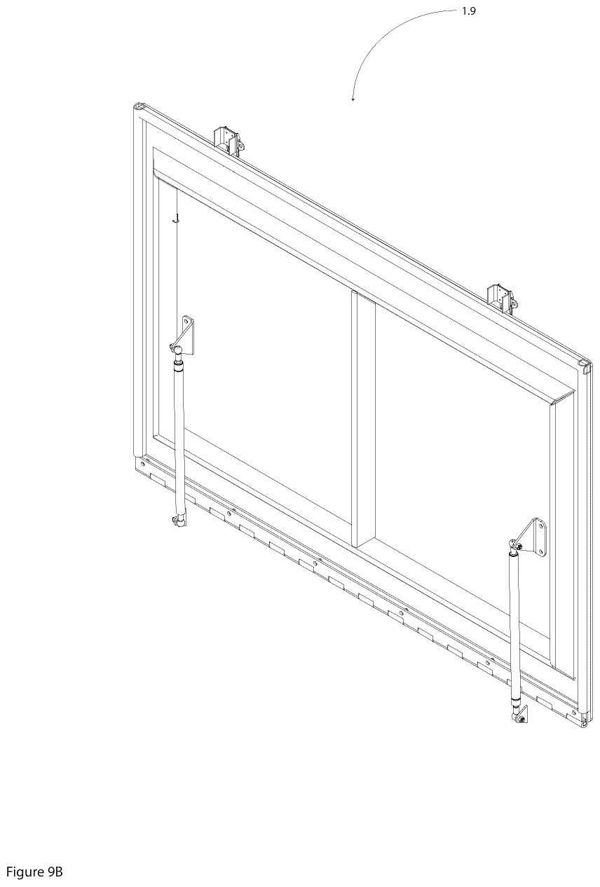

As is best shown in FIG. 9A-9B, front compartment cover assembly 1.9 of tug 100 preferably includes turn-to-open draw latches 9.1, piano hinge 9.2, gas spring tabs 9.3-4, top cover 9.5, lid stiffeners 9.6-8, latch mounting brackets 9.9, gas springs 9.10, and seals 9.11-12.

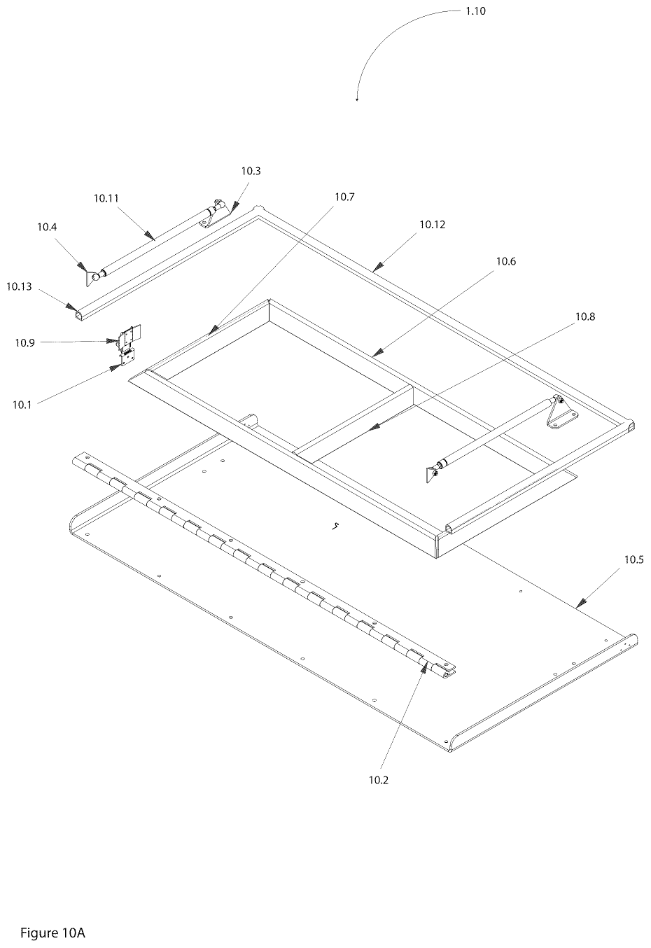

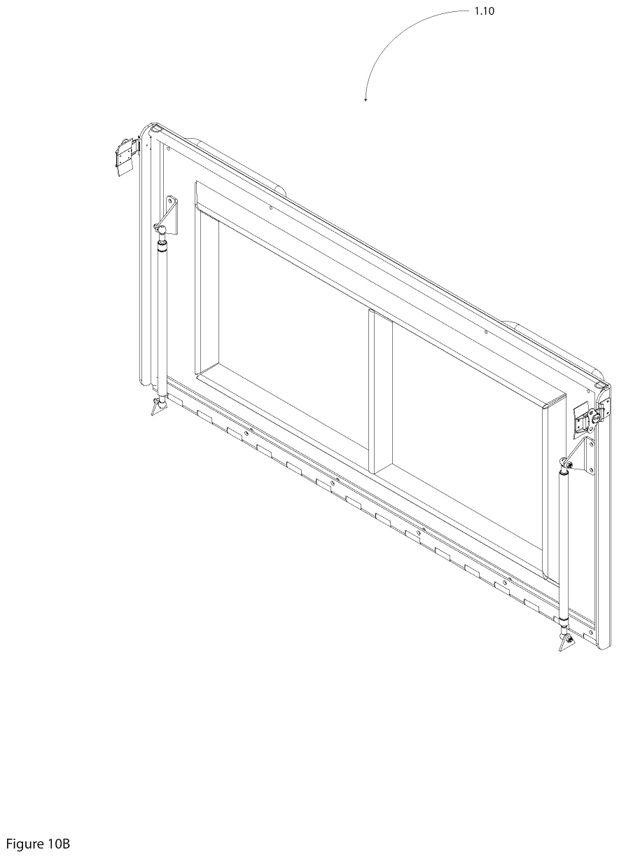

Referring now to FIGS. 10A-10B, rear compartment cover assembly 1.10 of tug 100 preferably includes turn-to-open draw latches 10.1, piano hinge 10.2, gas spring tabs 10.3-4, rear lid 10.5, lid stiffeners 10.6-8, latch tap plates 10.9, threaded-hole pull handles 10.10, gas springs 10.11, and seals 10.12-13.

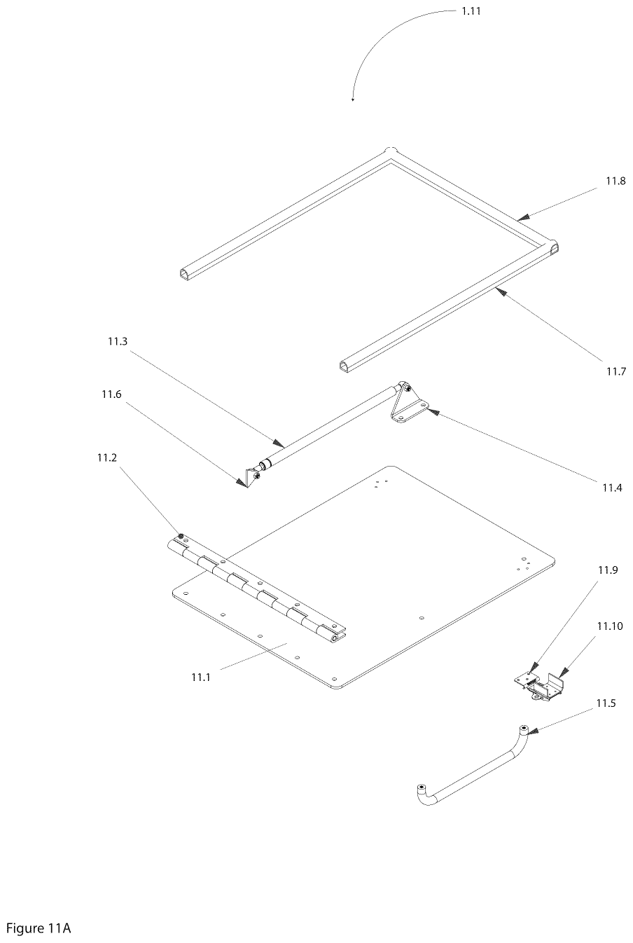

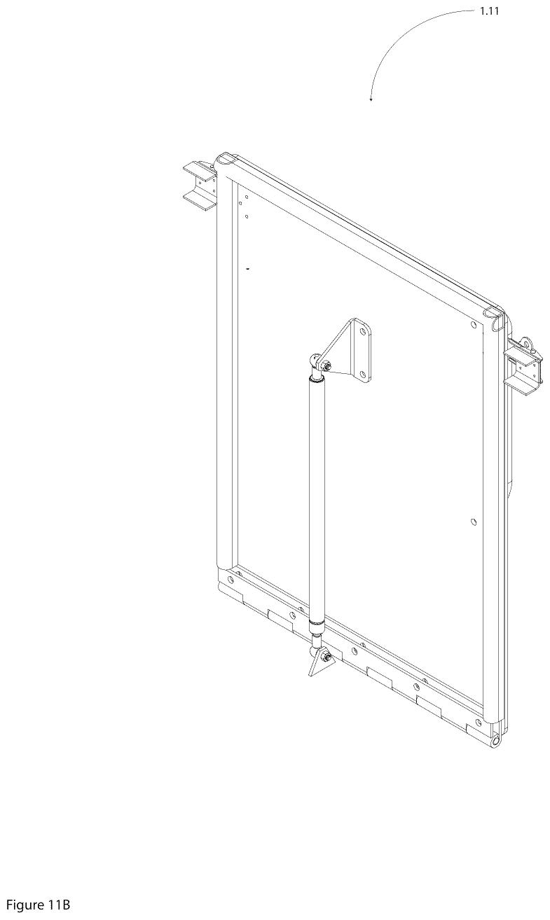

As is best shown in FIG. 11A-11B, tool storage cover 1.11 of tug 100 preferably includes panel 11.1, piano hinge without holes 11.2, gas spring 11.3, gas spring tab 11.4, extra-long threaded-hole pull handle 11.5, gas spring tab 11.6, seals 11.7-8, turn-to-open draw latches 11.9, latch mounting brackets 11.10.

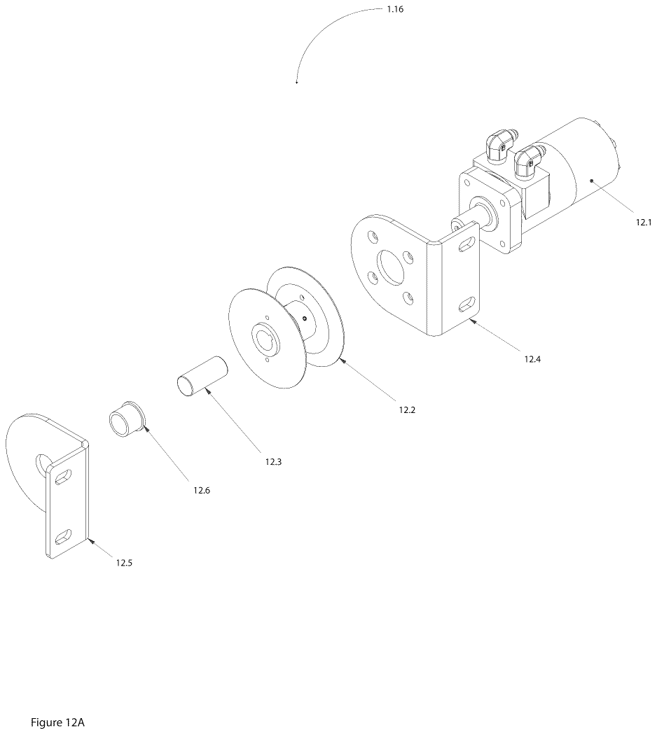

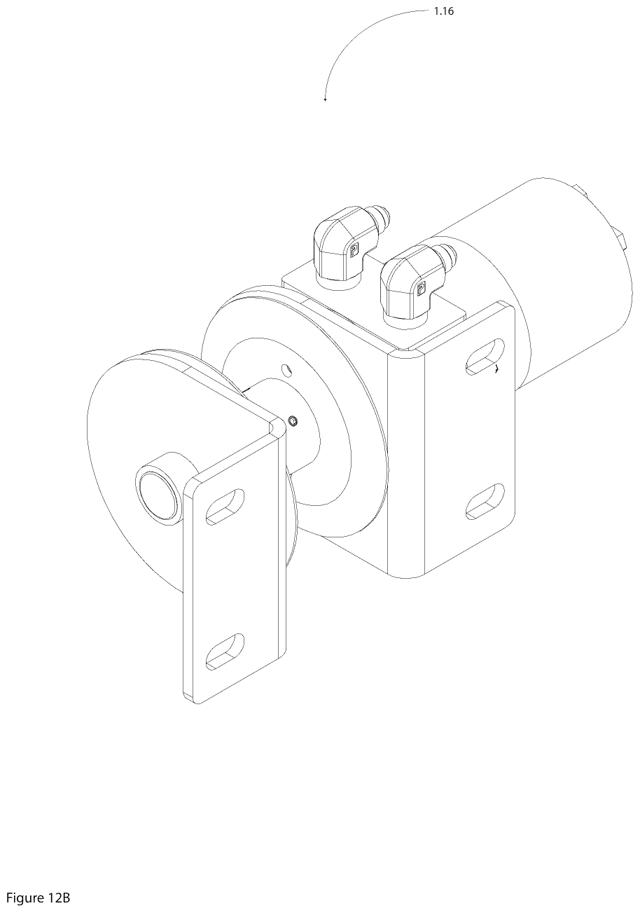

Referring now to FIGS. 12A-12B, strap winch assembly 1.16 of tug 100 preferably includes drive assembly 12.1, winch spool weldment 12.2, fasteners 12.3, winch side plates 12.4-5, and bushing 12.6.

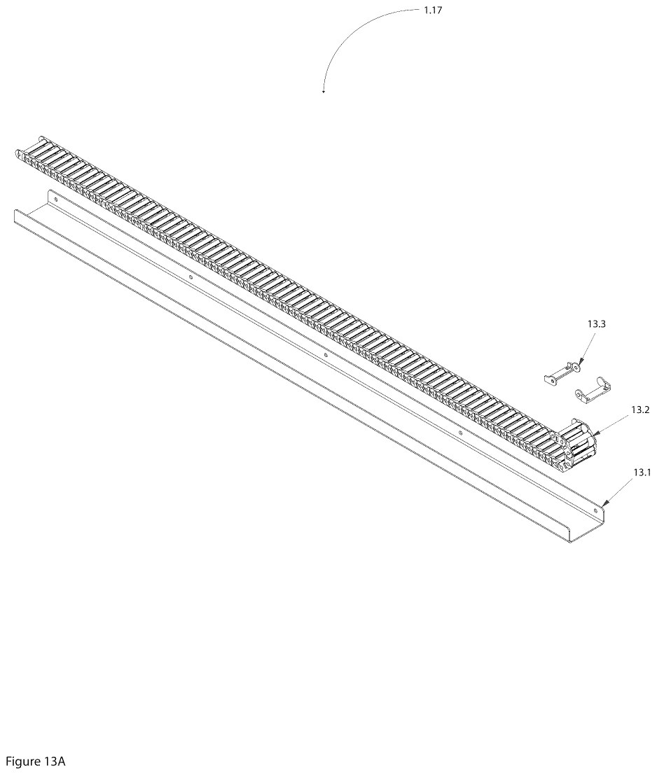

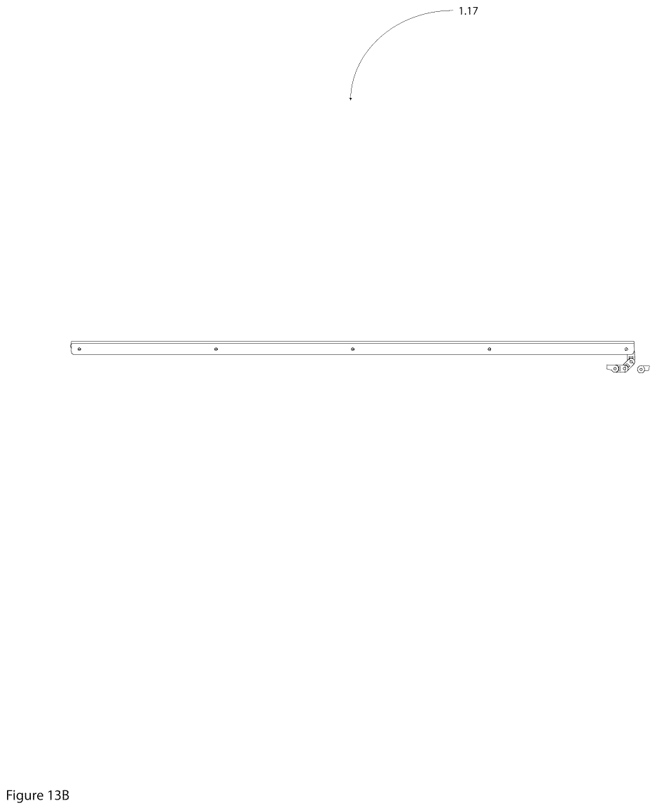

As is best shown in FIG. 13A-13B, wireway assembly 1.17 of tug 100 preferably includes wireway tray 13.1, snap-together cable and hose carrier 13.2, and wireway end meeting tabs 13.3.

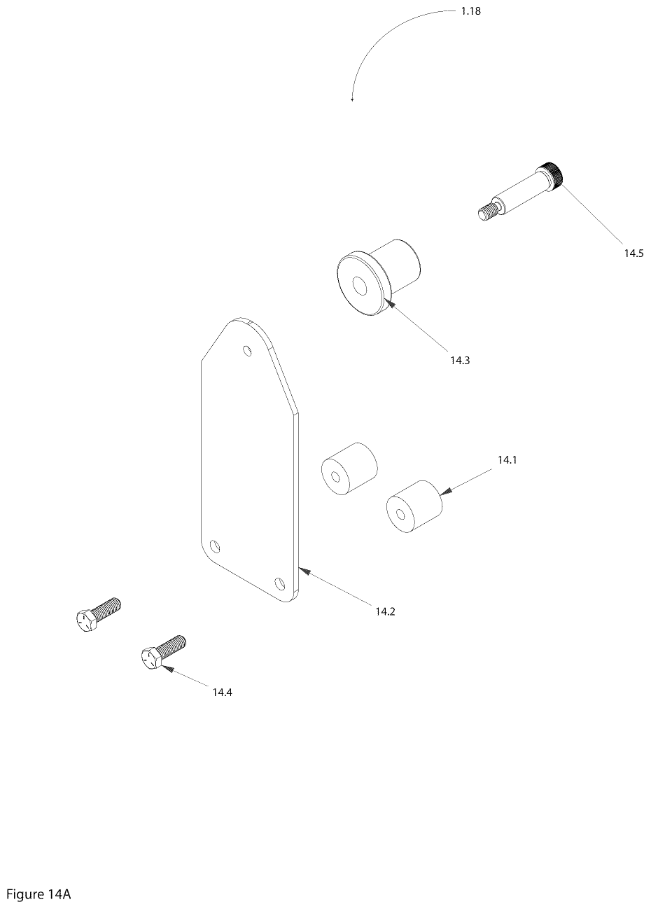

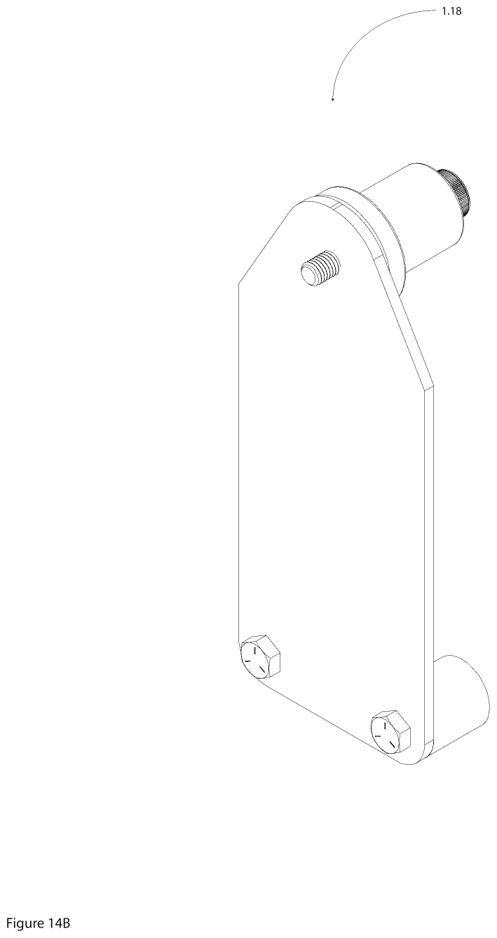

Referring now to FIGS. 14A-14B, wireway roller assembly 1.18 of tug 100 preferably includes wireway bosses 14.1, wireway roller plate 14.2, wireway roller 14.3, and fasteners 14.4-5.

In operation, the aircraft tug 100 utilizes its novel combination of low clearance front end design and extendable boom system to provide unprecedented maneuverability and visibility during aircraft ground operations. The side mast assemblies 1.5 can be controllably extended outward from their retracted positions, effectively increasing the operator's field of view around the aircraft being towed. This extension capability, combined with the pivoting function that allows the booms to be raised at their front ends, enables optimal positioning of safety monitoring equipment and lighting systems.

The front wheel scoop assembly 1.2 incorporates a multi-stage engagement mechanism that provides secure aircraft wheel capture while maintaining a significantly lower profile than conventional tugs. This is achieved through the coordinated operation of the front wheel paddle weldment 3.5, wheel paddle weldment 3.6, and scoop gate weldment 3.7, which work in concert to cradle and secure the aircraft's nose wheel. The scoop assembly's low profile design reduces the required lift height for aircraft engagement, thereby decreasing operational stress on both the tug and aircraft landing gear.

The tug's lift assembly 1.1 employs a novel hydraulic system architecture that provides precise control over lifting operations. The hydraulic cylinder 2.1 works in conjunction with the cylinder lift link 2.2 and lift links 2.3 to create a mechanically advantaged lifting motion that maintains stability throughout the entire lift range. This system allows for smooth, controlled lifting operations while requiring less hydraulic pressure than conventional designs, contributing to improved system longevity and reduced maintenance requirements.

A particularly innovative aspect of the present invention is the integration of the wireway assembly 1.17 and wireway roller assembly 1.18, which provide protected routing for control and power cables while maintaining full boom extension capability. The snap-together cable and hose carrier 13.2 allows for reliable cable management during boom movement, while the wireway roller assembly ensures smooth operation through the full range of boom extension and retraction. This integrated approach to cable management represents a significant improvement over conventional exposed cable designs.

The tug's electric drive system is specifically engineered for daily use applications, incorporating energy management systems derived from commercial electric vehicle technology. This configuration allows the tug to serve as a versatile ground support equipment (GSE) platform while maintaining the power and torque characteristics required for aircraft towing operations. The drive system includes regenerative braking capabilities and smart power management features that extend operational runtime between charging cycles.

The portable aircraft collision avoidance system integration is facilitated through a distributed sensor network that utilizes the extendable boom system as mounting points for proximity sensors and cameras. This arrangement provides superior coverage around the aircraft being towed while maintaining the system's portability. The sensor data is processed through a central control unit that provides real-time feedback to the operator through both visual and audible alerts, representing a significant advancement in ground operation safety systems.

The scoop connector assembly 1.7 incorporates a novel quick-release mechanism that allows for rapid engagement and disengagement with the aircraft while maintaining positive control throughout the towing operation. This is achieved through the coordinated geometry of the mast end plate 8.1 and front scoop side plates 8.2 and 8.3, which create a self-centering effect during engagement operations. The assembly's design ensures consistent engagement geometry regardless of variations in aircraft nose wheel size within its operational range.

The steering console assembly 1.4 integrates advanced control systems within an ergonomic operator interface, providing intuitive control over all tug functions while maintaining situational awareness during towing operations. The console's design facilitates single-operator control over all tug functions, including boom extension, lift operations, and drive control, while maintaining direct visual contact with critical operational zones around the aircraft.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and desired to be secured by Letters Patent of the United States is:

1. An aircraft tug for moving aircraft on the ground, comprising:
a chassis that is responsive to operator control;
at least one ground-engaging drive wheel, wherein the at least one ground-engaging drive wheel is associated with the chassis; and
wherein the tug includes a low clearance front and a boom/mast extension that increase visibility, as well as improve safety while transporting aircraft on the ground relative to conventional tugs.

2. The aircraft tug according to claim 1, wherein the aircraft tug is configured as an affordable, daily use electric vehicle.

3. The aircraft tug according to claim 1, wherein the aircraft tug is adapted to be integrated with a portable aircraft collision avoidance system.

4. The aircraft tug according to claim 1, further comprising a lift assembly.

5. The aircraft tug according to claim 1, further comprising a front wheel scoop assembly.

6. The aircraft tug according to claim 1, further comprising a front axle assembly.

7. The aircraft tug according to claim 1, further comprising a steering console assembly.

8. The aircraft tug according to claim 1, further comprising a side mast assembly having a pair of extendable side masts.

9. The aircraft tug according to claim 1, further comprising a scoop connector assembly.

10. The aircraft tug according to claim 1, further comprising a back wall mount hitch receiver.

11. The aircraft tug according to claim 1, further comprising a strap winch assembly.

12. The aircraft tug according to claim 1, further comprising a wireway assembly.

13. The aircraft tug according to claim 1, further comprising a wireway roller assembly.

14. The aircraft tug according to claim 1, further comprising a lift assembly, a front wheel scoop assembly, a front axle assembly, a steering console assembly, a side mast assembly having a pair of extendable side masts, a scoop connector assembly, a wall mount hitch receiver, a strap winch assembly, a wireway assembly, and a wireway roller assembly.

15. An aircraft tug system, comprising:
a chassis having a low clearance front portion;
a multi-stage wheel engagement assembly mounted in the front portion, comprising:
laterally adjustable wheel guides;
a rear gate mechanism; and
synchronized actuators configured to coordinate movement of the wheel guides and rear gate;
a pair of extendable side mast assemblies mounted to the chassis; and
a control system configured to manage the wheel engagement assembly and side mast assemblies.

16. The aircraft tug system according to claim 15, wherein each side mast assembly comprises:
a telescoping boom section;
a pivot mechanism configured to raise a front portion of the boom section; and
an integrated wireway assembly configured to manage cables throughout boom extension and pivot movements.

17. A method of engaging an aircraft with an aircraft tug, comprising the steps of:
positioning a low clearance front end of the tug beneath an aircraft nose wheel;
activating a sequential engagement process wherein: (a) lateral wheel guides move inward to establish initial wheel contact; (b) a rear gate deploys to prevent wheel rollback; and (c) the lateral wheel guides and rear gate coordinate to center and secure the wheel;
verifying secure wheel engagement through multiple sensor inputs; and
activating a lift assembly to raise the secured wheel while maintaining the wheel's centered position.

18. The method according to claim 17, further comprising the steps of:
extending a pair of side mast assemblies outward from the tug after wheel engagement;
activating proximity sensors mounted on the side mast assemblies; and
monitoring a safety envelope around the tug and aircraft during towing operations.

19. An electric aircraft tug drive system, comprising:
at least one electric drive motor coupled to ground-engaging wheels;
a power management system configured to:
distribute power between drive and lift operations;
implement regenerative braking; and
maintain reserve power for safety systems;
a thermal management system integrated with the drive motor; and
a charging interface compatible with ground support equipment power sources.

20. The electric aircraft tug drive system according to claim 19, wherein the power management system includes:
continuous monitoring of power consumption during operations;
automatic power reduction during extended idle periods; and
prioritized power distribution to critical systems during low power conditions.
